(19) United States
(12) Patent Application Publication
(10) Pub. No.: US 2021/0088401 A1
(43) Pub. Date: Mar. 25, 2021

(54) LOW-PRESSURE SENSOR DEVICE AND USE OF AN INLET CONNECTOR PIECE AS A FLUID INLET FOR A LOW-PRESSURE SENSOR DEVICE

(71) Applicant: Robert Bosch GmbH, Stuttgart (DE)

(72) Inventors: Christian Hauer, Remshalden (DE); Torsten Mais, Ciudad De Mexico Santa Fe (MX); Masoud Habibi, Schwieberdingen (DE); Thorsten-Kai Janitza, Stuttgart (DE)

(21) Appl. No.: 16/635,444

(22) PCT Filed: Jul. 11, 2018
(86) PCT No.: PCT/EP2018/068769

§ 371 Date: Jan. 30, 2020

(30) Foreign Application Priority Data
Aug. 3, 2017 (DE) 102017213530.1

(51) Int. Cl. G01L 19/00; G01L 23/24; G01L 23/26; G01K 13/02

(52) U.S. Cl. CPC G01L 19/0092; G01L 23/24; G01K 2013/024; G01K 13/02; G01L 23/26

(57) ABSTRACT

A low-pressure sensor device for measuring a charge pressure of an engine in a vehicle is described. The low-pressure sensor device has a pressure sensor for measuring the pressure of a fluid in the low-pressure sensor device, and a temperature sensor for measuring the temperature of the fluid in the low-pressure sensor device, the low-pressure sensor device having an in particular essentially cylindrical inlet connector piece for admitting the fluid into the low-pressure sensor device, the inlet connector piece having an in particular circular inlet opening on a side facing away from the pressure sensor.

### FIELD

The present invention relates to a low-pressure sensor device and to the use of an inlet connector piece as a fluid inlet for a low-pressure sensor device.

### BACKGROUND INFORMATION

Low-pressure sensor devices for measuring the charge pressure of an engine in a vehicle are often equipped with a temperature sensor. The temperature sensor protrudes into an inlet connector piece and has the task of measuring the temperature of the measuring fluid, usually air, without delay, if possible. In order to protect the temperature sensor from being touched during the installation and operation, the inlet connector piece has a closed development.

The low-pressure sensor device is often used in an environment in which high air humidity may prevail and water droplets and/or a water film may form. In particular at low external temperatures or ambient temperatures, this can cause ice to build up.

In particular, when the ice is unable to melt again on account of low ambient temperatures but instead increases steadily, this may cause the inlet opening of the inlet connector piece or the low-pressure sensor device to close up (fluid-tight or air-tight), or in other words, to freeze over. Now, no fluid is able to reach the low-pressure sensor device and thus no fluid is able to reach the engine either.

### SUMMARY

Specific embodiments of the present invention may advantageously make it possible to prevent freezing of the fluid inlet opening of a low-pressure pressure sensor device.

According to a first aspect of the present invention, a low-pressure sensor device for measuring a charge pressure of an engine in a vehicle is provided, the low-pressure sensor device including a pressure sensor for measuring the pressure of a fluid in the low-pressure sensor device, and a temperature sensor for measuring the temperature of the fluid in the low-pressure sensor device, the low-pressure sensor device in particular having an essentially cylindrical inlet connector piece for admitting the fluid into the low-pressure sensor device, the inlet connector piece having an in particular circular inlet opening on a side facing away from the pressure sensor, characterized in that the inlet connector piece has a sieve-type wall structure which includes a multitude of recesses in a subregion facing the inlet opening.

This has the advantage that freezing of the inlet opening is often essentially prevented. The recesses may normally freeze over and protect the inlet opening from freezing or from moisture that enters the low-pressure sensor device. In general, the low-pressure sensor device may therefore also be used in cold and very cold regions, in particular regions featuring permafrost, e.g., in Scandinavia, Canada and Siberia, without the inlet opening freezing up. In particular when the moisture reaches a side of the inlet connector piece from a lateral direction, the recesses may often freeze over on this side, so that the developed ice layer protects the recesses that are situated on the opposite side from the moisture and thus from freezing over. When an ice layer forms on the wall of the low-pressure device, the inlet connector piece may generally protrude through the ice layer (in the way of a snorkel) so that the inlet opening remains (at least partially) open. In addition, the temperature sensor is typically protected during the installation and in an operation.

According to second aspect of the present invention, the use of an inlet connector piece as a fluid inlet for a low-pressure sensor device for measuring a charge pressure of an engine in a vehicle is provided, the low-pressure sensor device having a pressure sensor for measuring the pressure of the fluid in the low-pressure sensor device and a temperature sensor for measuring the temperature of the fluid in the low-pressure sensor device, characterized in that the inlet connector piece has a sieve-type wall structure which includes a multitude of recesses in a subregion facing away from the pressure sensor.

One advantage in this context is that freezing of the inlet opening is typically prevented for the most part. When using such an inlet connector piece as a fluid inlet, the recesses may usually freeze over and protect the inlet opening from freezing or from moisture entering the low-pressure sensor device. As a result, the use of such an inlet connector piece as a fluid inlet may make it possible to use the low-pressure sensor device also in cold and very cold regions, in particular regions featuring permafrost, e.g., in Scandinavia, Canada and Siberia, without the inlet opening freezing up. In particular when the moisture reaches a side of the inlet connector piece from a lateral direction, the recesses on this side may normally freeze over when using such an inlet connector piece as a fluid inlet; as a result, the recesses on the opposite side are protected from the moisture by the ice layer that has formed, which thus protects them from freezing up. In addition, the temperature sensor is typically protected during the installation and operation when such an inlet connector piece is used as a fluid inlet.

Features in connection with specific embodiments of the present invention may be considered to be based, among other things, on the thoughts and recognitions described in the following text.

According to one specific embodiment, the temperature sensor is at least partially situated at the level of the sieve-type wall structure of the inlet connector piece. This has the advantage that the fluid typically circulates well around the temperature sensor so that the temperature of the fluid is able to be detected and determined within a very short reaction time or delay time or a short response time.

According to one specific embodiment, the inlet connector piece has a completely closed wall structure in a subregion facing away from the inlet opening. As a rule, this reliably prevents the entry of fluid that is flowing along or down an outer wall of the low-pressure sensor device.

According to one specific embodiment, the inlet connector piece has an in particular circumferential drip-off edge at an end facing the inlet opening. This typically prevents the collection of water droplets at the inner surface of the inlet opening. Thus, the formation of ice in this location is prevented even better or suppressed as a rule.

According to one specific embodiment, the inlet connector piece is injection-molded in one piece. This has the advantage that the low-pressure sensor device is generally developed in a technically simple and cost-effective manner.

According to one specific embodiment, the sieve-type wall structure has recesses that are dimensioned and the temperature sensor is disposed in the inlet connector piece in such a way that touching of the temperature sensor by a part of a human hand of an adult person through the recesses is impossible. This is advantageous insofar as the temperature sensor is usually protected from damage in a technically uncomplicated manner.

According to one specific embodiment, the inlet connector piece has a rotationally symmetric development in relation to an axis of symmetry that extends from the temperature sensor to a center point of the inlet opening. One advantage of this is that the alignment of the inlet connector piece typically need not be considered when the low-pressure sensor device is assembled. From a technical standpoint, this usually simplifies the production of the low-pressure sensor device. In addition, it is generally unimportant from which direction moisture reaches the low-pressure sensor device.

According to one specific embodiment, the temperature sensor and/or the pressure sensor is/are situated on the axis of symmetry of the inlet connector piece. This is advantageous insofar as the temperature and/or the pressure of the fluid is/are normally able to be measured in a particularly rapid and precise manner.

According to one specific embodiment, the low-pressure sensor device also includes a sealing element, in particular an 0-ring, for sealing a transition region from the inlet connector piece to an inlet connector piece contact region of the low-pressure sensor device. Generally, this prevents fluid or moisture from entering the part of the low-pressure sensor device that directly abuts the inlet connector piece in a technically complicated manner. As a result, this typically ensures, for instance, that only air is flowing through the low-pressure sensor device.

It should be pointed out that some of the possible features and advantages of the present invention have been described here with reference to different specific embodiments of the low-pressure sensor device. It will be recognized by those skilled in the art that the features may be suitably combined, adapted or exchanged in order to obtain further specific embodiments of the present invention.

### BRIEF DESCRIPTION OF THE DRAWINGS

Below, specific example embodiments of the present invention are described with reference to the figures, but neither the figures nor the description should be regarded as limiting the present invention.

FIG. 1 shows a perspective view of a specific embodiment of the low-pressure sensor device according to the present invention.

FIG. 2 shows a cross-sectional view of the low-pressure device from FIG. 1.

FIG. 3 shows a detailed side view of the inlet connector piece of the low-pressure sensor device from FIGS. 1 and 2.

The figures are merely schematic and not true to scale. Identical reference numerals in the figures denote the same features or features that act in the same way.

### DETAILED DESCRIPTION OF EXAMPLE EMBODIMENTS

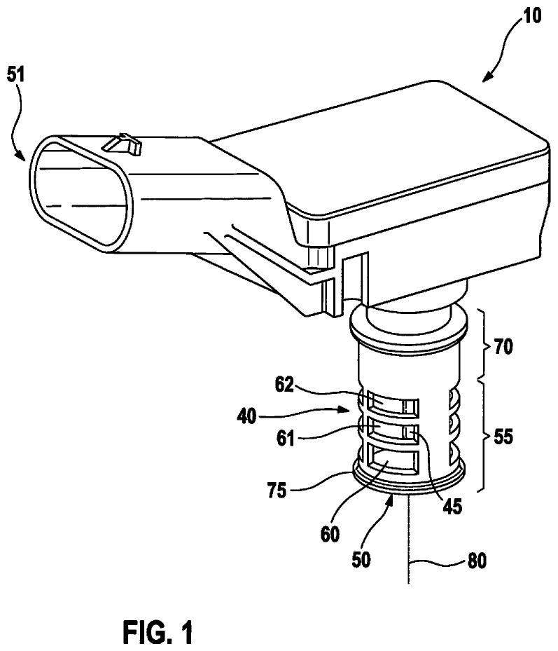

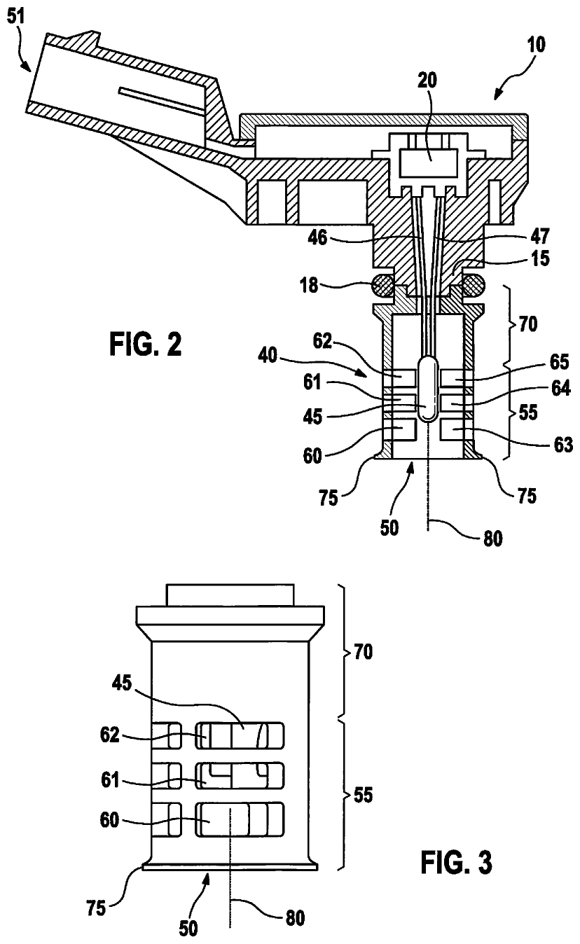

FIG. 1 shows a perspective view of a specific example embodiment of low-pressure sensor device 10 according to the present invention. FIG. 2 shows a cross-sectional view of low-pressure sensor device 10 from FIG. 1. FIG. 3 shows a detailed side view of inlet connector piece 40 of low-pressure sensor device 10 from FIG. 1 and FIG. 2.

Low-pressure sensor device 10 is provided for measuring a charge pressure of an engine in a vehicle. Toward this end, low-pressure sensor device 10 has a pressure sensor 20 for measuring the pressure of air in low-pressure sensor device 10. Low-pressure sensor device 10 includes an inlet connector piece 40, which has an inlet opening 50 so that air may flow or be aspirated into low-pressure sensor device 10. The air is routed to pressure sensor 20. There, pressure sensor 20 measures the pressure. Via a discharge opening 51, the air leaves low-pressure sensor device 10.

Inlet connector piece 40 is able to be separated from the rest of low-pressure sensor device 10. Via its upper side in FIG. 3, inlet connector piece 40 is inserted into the other part of low-pressure sensor device 10 or into an inlet connector piece contact region 15 of low-pressure sensor device 10. An O-ring 18 is used as a sealing element between inlet connector piece contact region 15 and inlet connector piece 40. A protrusion of inlet connector piece 40 functions as a stop so that inlet connector piece 40 will not be inserted too deeply into the remaining part of low-pressure sensor device 10.

In a side view, low-pressure sensor device 10 essentially has the form of a Latin capital letter L. Pressure sensor 20 is situated in the “corner” of the capital letter L. Inlet connector piece 40 essentially has the form of a (largely) hollow cylinder.

Inlet connector piece 40 has in its upper subregion 70 in FIG. 3 (i.e., the subregion facing pressure sensor 20) an essentially completely closed wall structure. In other words, inlet connector piece 40 has no recesses 60-65 in the wall in that location.

In a lower subregion 55 of inlet connector piece 40 in FIG. 3, which directly abuts upper subregion 70, the wall of inlet connector piece 40 has a sieve-type structure. A sieve-type structure particularly means that the wall has a multitude of recesses 60-65. Recesses 60-65 may be large, in particular in comparison to the other regions of the wall between recesses 60-65, preferably at least twice as large. Recesses 60-65 may be situated at regular intervals. An irregular placement is possible as well.

The sieve-type wall structure need not extend across the entire circumference (extending from the left to the right in FIG. 3) but lower subregion 55 of inlet connector piece 40 can also have a closed wall structure in some angular ranges.

Upper subregion 70 has a shorter length than lower subregion 55 of inlet connector piece 40. The sieve-type wall structure may be adapted to the installation angle or the installation position of the low-pressure sensor device.

Temperature sensor 45 is situated in inlet connector piece 40. Temperature sensor 45 may particularly be disposed in a fixed position in inlet connector piece 40. Temperature sensor 45 is positioned in inlet connector piece 40 in a centered manner, i.e., is equidistantly set apart from all walls. However, a non-centered placement in inlet connector piece 40 is possible as well. Temperature sensor 45 is attached to pressure sensor 20 by two suspensions 46, 47. Suspensions 46, 47 are also able to transmit the signal from temperature sensor 45 to pressure sensor 20.

Temperature sensor 45 or the temperature measuring device is situated in inlet connector piece 40 in such a way and recesses 60-65 have a size such that touching of temperature sensor 45 through recesses 60-65 by a part of an average human hand is not possible.

In particular, temperature sensor 45 may include a thermal resistor or NTC resistor or NTS thermistor or be made up of such.

The air or moisture reaches low-pressure sensor device 10 from a lateral side such as from the left in FIG. 2. The moisture may freeze given the right ambient or outside temperatures. If the ice layer that is produced as a result there does not melt, then the initially thin ice layer continues to grow.

Because of the ice, some recesses or all recesses 60-65 on one side (such as on the left side in FIG. 2) are closed. The entry of moisture into inlet connector piece 40 is therefore essentially reduced or prevented. This also makes it possible for inlet opening 50 of inlet connector piece 40 not to freeze up completely.

Air is always able to pass through inlet opening 50 into inlet connector piece 40. Freezing of recesses 60-65 on one side also prevents moisture from reaching recesses 60-65 on the opposite side (e.g., on the right side in FIG. 2). As a result, freezing of these recesses 60-65 is reduced or prevented.

Inlet connector piece 40 may be developed in rotational symmetry with an axis of symmetry 80. Axis of symmetry 80 extends from pressure sensor 20 to temperature sensor 45 or to a center point of inlet opening 50. Axis of symmetry 80 in FIG. 2 and in FIG. 3 thus runs from top to bottom.

On a side facing away from pressure sensor 20, i.e., on a lower side in FIG. 2 or FIG. 3, the sensor connector piece has a drip-off edge 75. Drip-off edge 75 includes an outwardly projecting protrusion. Drip-off edge 75 essentially surrounds inlet opening 50 completely. Drip-off edge 75 therefore has a circular development.

Drip-off edge 75 ensures that water droplets do not collect or remain at the lower side of inlet connector piece 40 or at the inner side of inlet connector piece 40 but instead drip off due to gravitation.

The diameter of inlet connector piece 40 perpendicular to axis of symmetry 80 is relatively large. The diameter may amount to approximately 12 mm, for example.

As a rule, low-pressure sensor device 10 is placed in the vehicle equipped with the internal combustion engine in such a way that the gravitation in FIG. 2 and FIG. 3 runs from top to bottom.

Inlet connector piece 40 is able to be produced in one piece using an injection molding tool.

Temperature sensor 45 is particularly fixed in place in low-pressure sensor device 10 without glue or without bonding.

In conclusion, it is pointed out that terms like “include”, “encompass”, etc. do not exclude other elements or steps and terms like “a” do not exclude a plurality.

1-10. (canceled)

11. A low-pressure sensor device for measuring a charge pressure of a motor in a vehicle, the low-pressure sensor device comprising:
a pressure sensor configured to measure a pressure of a fluid in the low-pressure sensor device;
a temperature sensor configured to measure a temperature of the fluid in the low-pressure sensor device; and
a cylindrical inlet connector piece configured to admit the fluid into the low-pressure sensor device, the inlet connector piece having a circular inlet opening on a side facing away from the pressure sensor, the inlet connector piece having a sieve-type wall structure which includes a multitude of recesses in a subregion facing the inlet opening.

12. The low-pressure sensor device as recited in claim 11, wherein the temperature sensor is at least partially situated at a level of the sieve-type wall structure of the inlet connector piece.

13. The low-pressure sensor device as recited in claim 11, wherein the inlet connector piece has a completely closed wall structure in a subregion facing away from the inlet opening.

14. The low-pressure sensor device as recited in claim 11, wherein the inlet connector piece has a circumferential drip-off edge at an end facing the inlet opening.

15. The low-pressure sensor device as recited in claim 11, wherein the inlet connector piece is injection-molded in one piece.

16. The low-pressure sensor device as recited in claim 11, wherein the sieve-type wall structure has recesses that are dimensioned in such a way and the temperature sensor is disposed in the inlet connector piece in such a way that touching of the temperature sensor by a part of a human hand of an adult person through the recesses is impossible.

17. The low-pressure sensor device as recited in claim 11, wherein the inlet connector piece is rotationally symmetric in relation to an axis of symmetry that extends from the temperature sensor to a center point of the inlet opening.

18. The low-pressure sensor device as recited in claim 17, wherein the temperature sensor and/or the pressure sensor is situated on the axis of symmetry of the inlet connector piece.

19. The low-pressure sensor device as recited in claim 11, further comprising:
an O-ring configured to seal a transition region from the inlet connector piece to an inlet connector piece contact region of the low-pressure sensor device.

20. A method of use of an inlet connector piece, comprising:
providing a low-pressure sensor device, the low-pressure sensor device including a pressure sensor configured to measure a pressure of a fluid in the low-pressure sensor device, a temperature sensor configured to measure a temperature of the fluid in the low-pressure sensor device, and a cylindrical inlet connector piece configured to admit the fluid into the low-pressure sensor device, the inlet connector piece having a circular inlet opening on a side facing away from the pressure sensor, the inlet connector piece having a sieve-type wall structure which includes a multitude of recesses in a subregion facing the inlet opening; and
using the inlet connector piece as a fluid inlet for the low-pressure sensor device for measuring a charge pressure of an engine in a vehicle.
